(19) United States
(12) Patent Application Publication
(10) Pub. No.: US 2003/0212994 A1
(43) Pub. Date: Nov. 13, 2003

(54) Remote monitoring system

(75) Inventors: John E. Fitzsimmons, Massapequa Park, NY (US); Denis P. Phillips, New York, NY (US); Michael G. Thaw, Ocean Township, NJ (US); Jacek J. Kikta, East Windsor, NJ (US); Jay L. Darish, Hightstown, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Radiant Communications Corporation

(21) Appl. No.: 10/198,017

(22) Filed: Jul. 17, 2002

Related U.S. Application Data
(63) Continuation of application No. 10/142,236, filed on May 9, 2002.

(51) Int. Cl. H04N 7/16; H04H 9/00; H04N 5/268; G06F 3/00; H04N 5/445; G06F 13/00; H04N 7/173

(52) U.S. Cl. 725/9; 348/705; 725/54; 725/90; 725/109

(57) ABSTRACT

A system for monitoring a selected channel signal included within a multiplex of channel signals and for transmitting a representation of the selected channel signal to a monitoring location is disclosed. The system includes a demultiplexer which receives the multiplex of channel signals and demultiplexes the selected channel signal in response to a channel select command. A transmitter unit receives the demultiplexed channel signal from the demultiplexer, compresses the demultiplexed channel signal, converts the compressed demultiplexed channel signal to a packet signal and transmits the packet signal to the monitoring location via a telecommunications link.

### CROSS-REFERENCE TO RELATED APPLICATIONS

This application is a continuation of copending U.S. patent application Ser. No. 10/142,236, filed May 9, 2002 entitled “Remote Monitoring System”.

### BACKGROUND OF THE INVENTION

The present invention relates to signal transmission systems and more particularly to a system for monitoring one or more signal channels at one or more locations within a broadband cable television signal distribution system, and transmitting signals representative of the channel signals to one or more monitoring locations.

A typical cable television distribution system comprises a headend, manned by operators, from which all of the programming existent on the system is distributed. Typically, a tree and branch type of distribution plant extends from the headend to subscribers of the CATV system, over which the programming is distributed to the subscribers. A typical headend may serve hundreds of thousands of subscribers in widely dispersed communities.

Embedded within the distribution plant are unmanned hubs each of which receives the programming from the headend. Typically, a hub serves the subscribers situated in a localized geographic region. Individual hubs typically have custom channel lineups and distribute custom advertising so as to particularize the programming provided to the local region.

The custom advertising for each local region is typically downloaded from the headend to the hub serving the region. The advertising is electronically stored in the hub until it is needed. It is not unusual, however, for the headend to download the wrong file to the hub. This means that an advertisement meant for one geographic region might be shown by error in a different region. Additionally, the quality of a given channel signal distributed from the hub may be degraded due to equipment failure. Because of the possibility of transmitting a signal having degraded video or audio quality as well as the possibility that errors in programming may occur, there is a need of a capability for remotely monitoring the individual channels of a CATV signal distributed from each unmanned hub by personnel at the headend of the CATV system or at another monitoring location.

### BRIEF SUMMARY OF THE INVENTION

Briefly stated, the present invention comprises a system for monitoring a selected channel signal included within a multiplex of channel signals and transmitting a representation of the selected channel signal to a monitoring location. The system comprises a demultiplexer which receives the multiplex of channel signals and demultiplexes the selected channel signal in response to a channel select command. The system also includes a transmitter unit which receives the demultiplexed channel signal from the demultiplexer, compresses the demultiplexed channel signal, converts the compressed demultiplexed channel signal to a packet signal and transmits the packet signal to the monitoring location via a telecommunications link.

In another aspect, the present invention comprises a transmitter unit for receiving a channel signal and for transmitting a representation of the channel signal to a monitoring location. The transmitter unit comprises an encoder unit which compresses the received channel signal to a bit rate, the bit rate being selectable to one of a fixed rate and a variable rate, the variable rate being determined to achieve a constant quality. The encoder converts the compressed channel signal to a packet signal for transmission to the monitoring location via a telecommunication link and adjusts a packet rate of the packet signal to conform to the bit rate of the compressed channel signal. The transmitter unit also includes an infrared control unit for receiving a demultiplexer command signal from the encoder unit and for transmitting the demultiplexer command signal by an infrared signal.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a schematic block diagram of a preferred embodiment of the present invention including a transmitter unit;

FIG. 2 is a schematic block diagram of the transmitter unit shown in FIG. 1;

FIG. 3 is a functional block diagram of the encoder unit shown in FIG. 2; and

FIG. 4 is a functional block diagram of the of the IR control unit shown in FIG. 2.

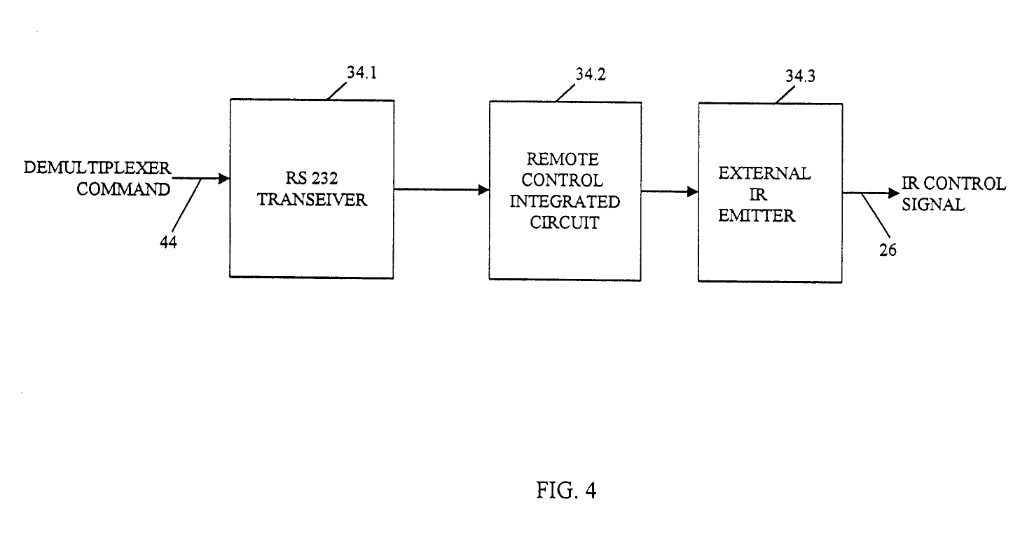

### DETAILED DESCRIPTION OF THE INVENTION

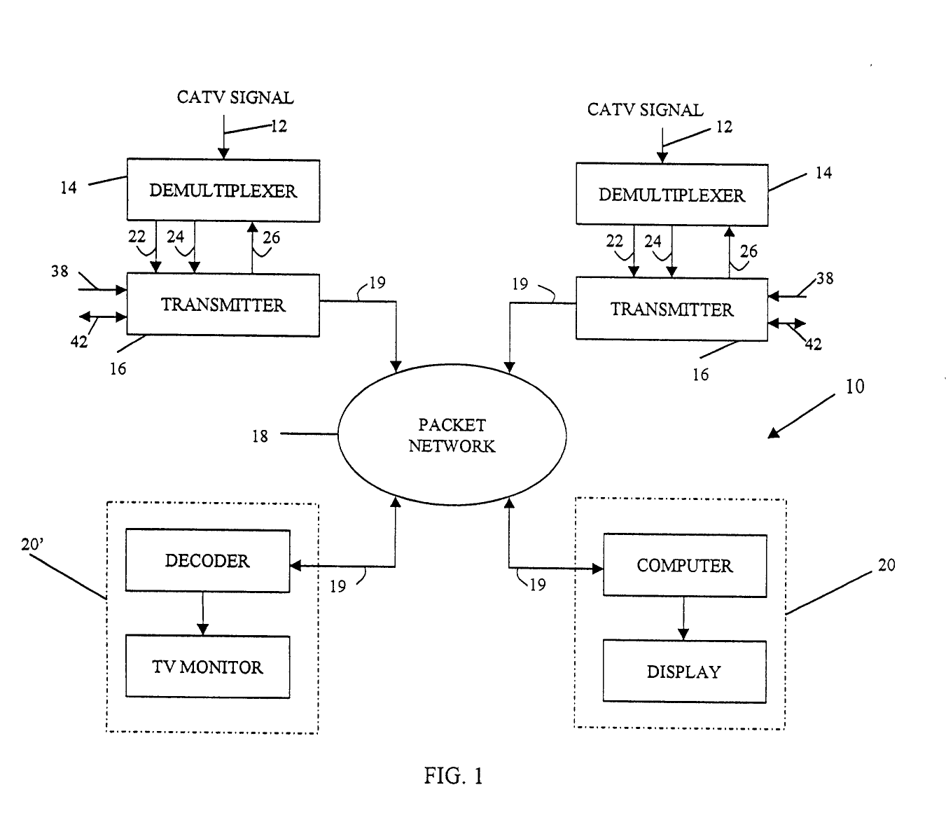

Referring to the drawings, wherein like numerals are used to indicate like elements throughout the several figures and the use of the indefinite article “a” may indicate a quantity of one, or more than one, of an element, there is shown in FIG. 1 a schematic block diagram of a preferred embodiment of a system 10 for monitoring at one or more locations, a selected channel signal included within a multiplex of channel signals 12 and for transmitting a representation of the selected channel signal to one or more monitoring locations. Preferably, the system 10 finds utility in a cable television (CATV) signal distribution system in which the system 10 is deployed at one or more unmanned hubs of the CATV distribution system for relaying the representation of a selected channel signal to the monitoring location where the content and/or quality of the selected channel signal at the hub can be evaluated by a person. Typically, the monitoring location is at a headend of the CATV system, which is normally manned. However, the monitoring location could be located any place where a telecommunications link could be connected between the monitoring location and the monitored location. Further, the system 10 is not limited to use in a CATV system. The system 10 can be utilized in other multiplexed signal distribution systems in which a representation of a channel signal selected from a plurality of multiplexed signals is required to be transmitted to a monitoring location.

Preferably, the multiplex of channel signals 12 is a frequency division multiplex (FDM) CATV signal 12, having a frequency range from about 54 MHz to about 856 MHz. Preferably, a channel signal within the CATV signal 12 is an analog signal, conforming to the National Television Standards Committee (NTSC) standard or the Phase Alternating Line (PAL) Standard. A channel signal also may be a digital signal, such as a high definition television (HDTV) signal conforming to one of the Moving Picture Experts Group standards (e.g. MPEG-1, MPEG-2 or MPEG-4), and modulated on an FDM carrier by 64/256 quaternary amplitude modulation.

Preferably, the system 10 includes a demultiplexer unit 14 which receives the multiplex of channel signals 12 at the monitored location, and demultiplexes, demodulates and outputs a selected channel signal in response to an IR control signal 26 received via an infrared sensor (not shown). The IR control signal 26 includes commands for selecting a channel to be demultiplexed and demodulated and for adjusting parameters associated with the selected channel. The IR control signal 26 also includes a mode command which initiates a diagnostic mode whereby the demultiplexer unit 14 outputs a diagnostic signal which includes parameters associated with the selected channel signal, such as signal-to-noise ratio and signal strength, instead of outputting the demultiplexed channel signal. Preferably, the selected demultiplexed and demodulated channel signal or the selected diagnostic signal is output from the demultiplexer unit 14 as a baseband composite video signal 22 conforming to the NTSC or the PAL standards, and a separate baseband audio signal 24. Preferably, the demultiplexer unit 14 is a commercially available set-top box such as a Scientific Atlanta Model No. Explorer 2100, manufactured by Scientific-Atlanta, Inc., responsive to infrared signals for selecting the channel to be monitored, setting characteristics of the demultiplexed channel signal, such as the level of the audio channel, and for setting the mode of the set-top box. However, set-top boxes available from other manufacturers would be equally suitable for use as the demultiplexer unit 14.

As will be appreciated by those skilled in the art, the demultiplexer unit 14 is not limited to being a set-top box for demultiplexing the CATV signal 12 described above. Demultiplexer units 14 which demultiplex, demodulate and output a channel signal encoded and modulated according to other techniques, as may developed in the future, and multiplexed with such other techniques as time division multiplexing and code division multiplexing are within the spirit and scope of the invention. Further, the demultiplexer 14 may provide the audio signal 24 and the video signal 22 in a digital format and still be within the spirit and scope of the invention.

In the preferred embodiment of the system 10, a transmitter unit 16 receives the demultiplexed and demodulated channel signal or the diagnostic signal from the demultiplexer unit 14 and digitizes and compresses the channel signal as described below. The transmitter unit 16 also receives a serial data signal 42 and one or more alarm signals 38, each of which are multiplexed with the compressed channel signal. The transmitter 16 converts the multiplexed compressed channel signal, the serial data signal 42 and the alarm signals 38 to a packet signal 19 and thereafter transmits the packet signal 19 to one or more of the monitoring locations via a telecommunications link 18. Preferably, the packet signal 19 is transmitted to the monitoring locations using transport control protocol (TCP), User Datagram Protocol (UDP) or UDP Private protocol. However, as would be appreciated by those skilled in the art, the above packet protocols may be supplemented with additional protocols, or other packet protocols could be substituted for the preceding protocols and such protocols are considered to be within the spirit and scope of the invention.

Preferably, the telecommunication link 18 includes a packet network comprising wire, optical, or wireless media, or a combination of the preceding. The packet network may be either a wide area network (WAN), a local area network (LAN), a metropolitan area network (MAN) or a combination of the preceding. Other types of telecommunications links 18 such as the circuit switched links used in the public switched telephone network, the return channel of the CATV network being monitored or a dedicated point-to-point telecommunications link such as a T1 line can also be used, either alone or in combination with the packet network.

Preferably, the system 10 also includes a monitoring station 20, 20′ located at each of the monitoring locations and connected to the transmitter unit 16 by the telecommunication link 18. Preferably, each monitoring station includes a video display and an audio reproducer (not shown) for viewing and listening to the packet signal 19 received by the monitoring station 20, 20′. One type of the monitoring station 20, 20′ is an administration device 20 capable of configuring each demultiplexer 14 and an associated transmitter 16 by: (1) transmitting a channel select command to the associated transmitter unit 16 via the communication link 18 which selects the channel within the multiplex of channel signals to be demultiplexed, (2) transmitting a configuration command to the associated transmitter unit 16 via the communication link 18 which sets a bit rate, a picture format, a temporal quantization and a spatial quantization of the selected channel signal and (3) setting the mode of the demultiplexer unit 14 to a diagnostic mode in which the demultiplexer unit 14 outputs parameters associated with the selected channel signal.

Preferably the administration device 20′ is a desk top or a portable personal computer, having an attached video display and running the Windows™ operating system. The computer includes an application computer program, operable with the Windows™ operating system which executes in the computer for receiving the packet signal 19, converting the packet signal 19 to the compressed video and audio signals, and decoding the compressed video and audio signals to a form suitable for displaying the video portion of the received packet signal 19 on the attached video display and for driving a speaker or other audio reproducer for reproducing audio portion of the received packet signal 19. Preferably, the application software includes video and audio decoding algorithms which match video and audio encoding algorithms used the transmitter unit 16 for encoding the video and audio signals transmitted by transmitter unit 16, as described below.

The application program also forms the commands (described above) for controlling the transmitter unit 16 and the demultiplexer unit 14 including, but not limited to the channel select command, the mode command and the configuration command. Preferably, a command is formed by selecting an option in a dialog box displayed on the attached video display, by keyboard or mouse input, in which the user can, for example: (1) select the channel among the multiplex of channels signals to be demultiplexed, (2) determine the mode of the demultiplexer and (3) set the bit rate, the picture format, the temporal quantization and the spatial quantization of the demultiplexed compressed channel signal. The application program may written in any standard programming language, such as C++ or Visual Basic using techniques well known to those skilled in the art, and is not further discussed here for the sake of brevity.

Another type of monitoring station 20′ comprises a special purpose decoder which receives the compressed channel signal in the form of the packet signal 19, decodes the compressed channel signal and displays the decoded compressed channel signal on a conventional television monitor. Preferably, the monitoring station 20′ is remotely controlled from the administrative device 20 via the telecommunications link 18 for receiving the packet signal 19 from a specific one of the transmitters 16. Preferably, the special purpose device includes hardware and/or software for receiving the packet signal 19 via the telecommunication link 18, and for converting the packet signal 19 to a form suitable for driving the television monitor and a speaker or other audio reproducer. Preferably, the special purpose decoder is the commercially available VB6000 Video Processor Unit, manufactured by IndigoVision, Inc. of Campbell, Calif. However, the special purpose decoder is not limited to the VB6000 unit. Techniques for implementing the decoding functions in the decoder are well known and devices are commercially available for providing the decoding functions.

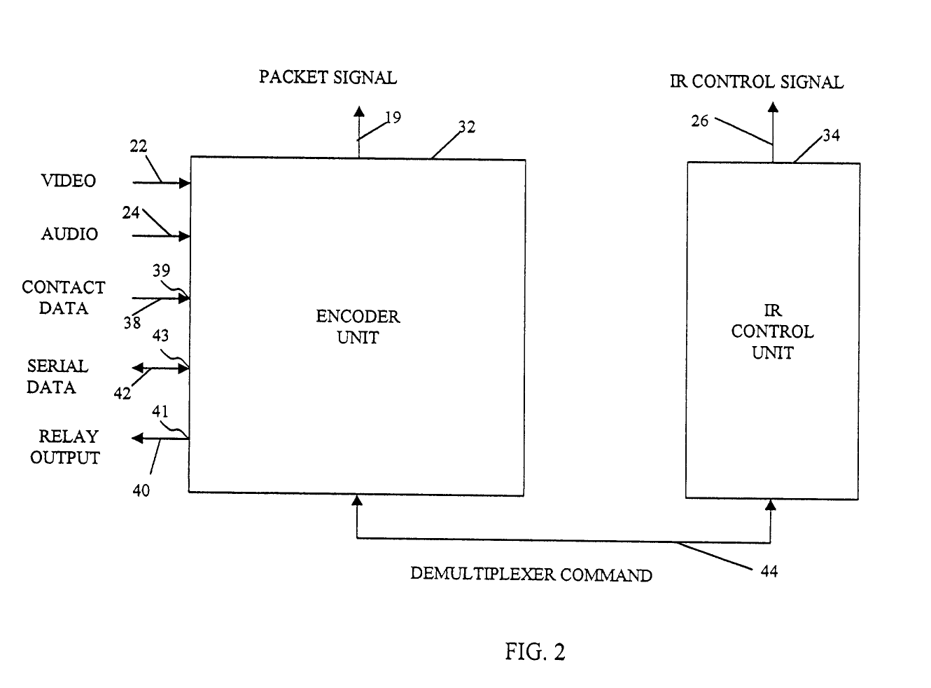

Referring now to FIG. 2, there is shown a schematic block diagram of the transmitter unit 16, according to the preferred embodiment. Preferably, the transmitter unit 16 comprises an encoder unit 32 which receives a channel signal as a baseband video signal 22 and a baseband audio signal 24. The encoder unit 32 digitally encodes the audio signal 24 to a fixed bit rate and encodes the video signal 22 to either: (1) a user selectable fixed bit rate or (2) a user selectable quality of the encoded video signal 22.

The encoder 32 also receives binary contact data 38 via four optically isolated contact data ports 39 which are generally used for alarm signals but may be used for other purposes, and provides two relay outputs 40 on relay output ports 41. The encoder also includes a serial data port 43 for transmitting and receiving serial data 42 to/from an external source. The encoder 32 converts the encoded audio signal 24, the encoded video signal 22, the serial data 42 and the contact data signals 32 to the packet signal 19 for transmission to the monitoring location via the telecommunication link 18.

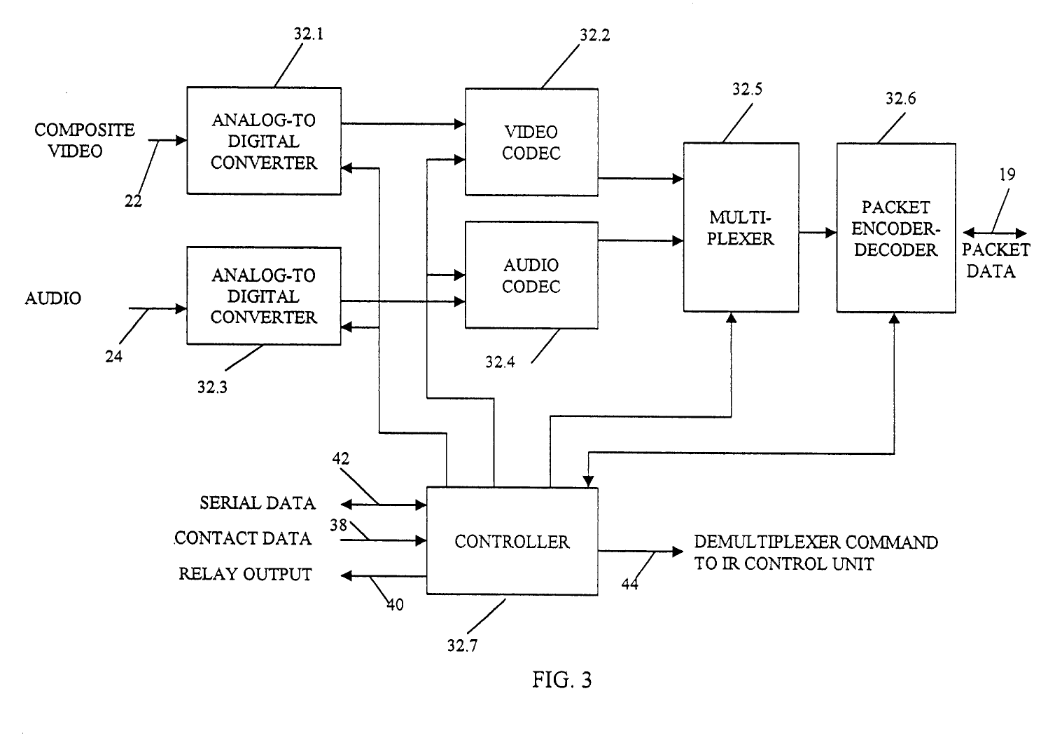

As shown in FIG. 3, the encoder unit 32 receives the channel signal in the form of a composite baseband video signal 22 and a baseband audio signal 24. Preferably, the video signal 22 conforms to the NTSC or the PAL video standard. However, the encoder unit 32 is not limited to accepting a video signal encoded in the NTSC or PAL format. A video signal 22 in another format, such as a SECAM signal, or in a digital format such as the HDTV format is also within the spirit and scope of the invention.

Preferably, the encoder unit 32 includes means for encoding the video signal 22 and the audio signal 24, and multiplexing the encoded video 22 and audio 24 signals with the serial data signal 42 and the contact data signal 38 in substantial conformance with the ITU standard H.320.

Preferably, the encoder unit 32 comprises an analog-to-digital converter 32.1 which digitizes the analog video signal 22 to form a high bit rate digital signal in a manner well known to those skilled in the art. Preferably, the encoder 32 also includes a video codec 32.2 which compresses the digitized video signal 22 using the discrete cosine transform (DCT), quantifies coefficients of the DCT and encodes the coefficients using run length encoding and entropy encoding, in conformance with the minimum standards of ITU standard H.261.

Preferably, the video codec 32.2 provides for compressing the video signal 22 to either a selectable fixed bit rate or to a variable bit rate in which the codec 32.2 realizes a constant quality of the encoded video signal 22. Preferably, the video codec 32.2 is responsive to the configuration command for setting the bit rate, the picture format, the temporal quantization and the spatial quantization of the encoded video signal 22. Preferably, the picture format is selectable between the well known common intermediate format (CIF) or quarter common intermediate format (QCIF). In either case, the packet rate of the packet signal 19 automatically adjusts to the bit rate of the encoded video signal 22.

The encoder 32 also includes an analog-to-digital converter 32.3 which digitizes the analog audio signal 24 to a nominal 64 Kbps rate. The preferred embodiment also includes an audio codec 32.4 which encodes the digitized audio signal 24 using the Low-Delay Code Excited Linear Prediction (LD-CELP) algorithm in conformance with the minimum requirements of ITU standard G.728. While it is preferred to utilize the G.728 standard for encoding audio at a 16 Kbps rate, the G.711 audio standard, encoding audio at a 64 Kbps rate is allowable under the H.320 standard, and is within the spirit and scope of the invention.

Further, while it is preferred that the encoder unit 32 encode the audio signal 24 and the video signal 22 conformance with the H.320 standard, one skilled in the art will recognize that the encoder unit 32 could also be constructed to conform to ITU standard H.323, which allows either the H.261 or H.263 ITU standards to be used for video encoding and the G.711, G.722, G.723 and G.728 ITU standards to be used for audio encoding. Further, as would be appreciated by one skilled in the art, the encoder unit 32 could also encode the video signal 22 in conformance with other techniques, such MPEG-1, MPEG-2, MPEG-4 or such other techniques for reducing the bit rate of the audio signal 24 and video signal 22 to a rate compatible with a packet network as these techniques were standardized.

The encoder 32 also includes a multiplexer 32.5 which receives the output from the video codec 32.2, the output from the audio codec 32.4 and serial/contact data 42,38 output from a controller 32.7. Preferably, the multiplexer combines the compressed video signal 22, the compressed audio signal 24, and the serial/contact data 42, 38 in accordance with ITU standard H.221, which is specified as part of ITU standard H.320. Consequently, the compressed video signal 22, compressed audio signal 24 and the serial/contact data 42, 38 are organized into fixed length frames that are each 80 bytes in length, each byte containing two bits of the compressed audio signal 24, two bits of the serial/contact data 42, 38 and 4 bits of the compressed video signal 22. As would be clear to those skilled in the art, the multiplexer 32.5 need not multiplex the compressed video signal 22, the compressed audio signal 24 and the serial/contact data 42, 38 to conform to H.221. For example, the compressed video signal 22, the compressed audio signal 24 and the serial/contact data 42, 38 could each be transmitted to the monitoring site as separate packets and still be within the spirit and scope of the invention.

Preferably, the encoder 32 also includes a packet encoder-decoder 32.6 which receives the 80 byte frames from the multiplexer 32.5 and converts 80 byte frames to the packet signal 19. Preferably the packet encoder-decoder utilizes Base 10/100 Ethernet protocol for connecting the transmitter 18 to the telecommunications link 18. Preferably, Internet Protocol and Transport Control Protocol are used to transfer of the packet signal 19 between the transmitter 16 and the monitoring station 20, 20′. Alternatively, the Internet Protocol in combination with User Datagram Protocol or User Datagram-Private protocol may be used for transferring the packet signal 19.

Preferably, the encoder 32 also includes a controller 32.7. The controller controls the analog-digital-converters 32.1, 32.3, the codecs 32.2, 32.4, the multiplexer 32.5 and a packet encoder-decoder 32.6. The controller also transmits/receives commands and serial data 42 via a serial data port 43, receives the binary contact data 38 via the four optically isolated contact data ports 39, and provides the two relay outputs 40 on relay output ports 41. The controller 32.6 also provides the demultiplexer command signals 44 to an IR control unit 34 as described below.

Preferably, the encoder unit 32 is a VB6000 Video Processor Unit, manufactured by IndigoVision, Inc. of Campbell, Calif. However, the encoder unit 32 is not limited to the VB6000 unit. Techniques for implementing the analog-to-digital converters 32.1, 32.3, video and audio codecs 32.2, 32.4, multiplexer 32.5 and packet encoder-decoder 32.6 are well known and devices are commercially available for providing the aforementioned functions.

Referring again to FIGS. 2 and 5, there is shown the IR control unit 34 used for receiving the demultiplexer command signals 44 from the encoder unit 32 via the RS-232 electrical interface and transmitting the IR control signal 26 to the demultiplexer 14 by infrared signals. As shown in FIG. 5, the IR control unit 34 comprises an RS-232 transceiver 34.1 for decoding serial asynchronous demultiplexer command signals 44 received from the encoder unit 32, a remote control integrated circuit 34.2 for converting the decoded demultiplexer command signals 44 to a 38 KHz pulse width modulated IR control signal 26 generally compatible with the remote control signaling used by home entertainment equipment, and an external IR emitter 34.3 connected by a cable to the transmitter 16 so that the external emitter 34.3 can be located proximate to the IR sensor on the demultiplexer 14. Preferably, the IR control signal 26 comprises the channel select command and the mode command. As would be clear to those skilled in the art, the IR control signal 26 may include additional commands, limited only by the range of commands supported by the demultiplexer unit 14.

Preferably, the IR Control unit 34 is commercially available from Innotech Systems, Inc. of Port Jefferson, N.Y. as model No. SP4001. However, the IR control unit 34 is not limited to the SP4001 unit. Techniques for implementing the RS-232 transceiver 34.1, the functions of the remote control integrated circuit 34.2 and the IR emitter 34.3 are well known and devices are commercially available for providing the aforementioned functions.

As will be appreciated by those skilled in the art, the present invention provides the means for remotely monitoring a channel signal within a multiplex of channel signals by transmitting a control signal to the monitoring location for selecting the channel to be monitored, controlling a demultiplexer, which may be a commercially available set-top box, by an infrared signal for tuning the demultiplexer to the selected channel, compressing the signal received from the selected channel and transmitting a low bit rate representation of the channel signal to a monitoring location for examination, thereby conserving bandwidth on the telecommunications link between the monitored location and the monitoring location.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A system for monitoring a selected channel signal included within a multiplex of channel signals and transmitting a representation of the selected channel signal to a monitoring location, the system comprising:
a demultiplexer receiving the multiplex of channel signals and demultiplexing the selected channel signal in response to a channel select command; and
a transmitter unit receiving the demultiplexed channel signal from said demultiplexer, compressing the demultiplexed channel signal, converting the compressed demultiplexed channel signal to a packet signal and transmitting the packet signal to the monitoring location via a telecommunications link.

2. The system according to claim 1, wherein the multiplex of channel signals comprises a cable television signal.

3. The system according to claim 1, wherein the demultiplexed channel signal comprises at least one of a baseband composite video signal and a baseband audio signal, the video signal substantially conforming with one of a National Television Standards Committee standard and a Phase Alternating Line standard.

4. The system according to claim 1, wherein said transmitter unit transmits the packet signal to the monitoring location using a protocol selected from the group consisting of transport control protocol (TCP), User Datagram Protocol (UDP) and UDP-Private.

5. The system according to claim 4, wherein said transmitter unit comprises an input for receiving at least one alarm signal, the at least one alarm signal being multiplexed with the compressed demultiplexed channel signal for incorporation into the packet signal for transmission to the monitoring location via the telecommunications link.

6. The system according to claim 1, said transmitter unit being responsive to a configuration command for setting at least one of a bit rate, a picture format, a temporal quantization and a spatial quantization of the compressed demultiplexed channel signal.

7. The system according to claim 1, said transmitter unit including an infrared control unit for transmitting the channel select command to said demultiplexer.

8. The system according to claim 1, said system further comprising a monitoring station located at the monitoring location and connected to said transmitter unit by the telecommunication link, said monitoring station comprising a video display for viewing the compressed demultiplexed channel signal.

9. The system according to claim 8, said monitoring station further including an administration device, said administration device being operable to provide for selecting the channel signal to be monitored.

10. The system according to claim 9, said administration device being operable to provide a configuration command to said transmitter unit for setting at least one of a bit rate, a picture format, a temporal quantization and a spatial quantization of the compressed selected channel signal.

11. The system according to claim 9, said administration device being operable to provide a mode command to said transmitter unit for setting said demultiplexer to a diagnostic mode whereby, instead of said demultiplexer outputting the demultiplexed channel signal of the selected channel to be received by said transmitter unit, said demultiplexer outputs parameters associated with the channel signal to said transmitter unit.

12. A transmitter unit for receiving a channel signal and transmitting a representation of the channel signal to a monitoring location, said transmitter unit comprising:
an encoder unit which compresses the received channel signal to a bit rate, the bit rate being selectable to one of a fixed rate and a variable rate, the variable rate being determined to achieve a constant quality, said encoder converting the compressed channel signal to a packet signal for transmission to the monitoring location via a telecommunication link and adjusting a packet rate of the packet signal to conform to the bit rate of the compressed channel signal; and
an infrared control unit for receiving a demultiplexer command signal from the encoder unit and transmitting the demultiplexer command signal by an infrared signal.

13. The transmitter unit according to claim 12, wherein the channel signal comprises at least one of a video signal and an audio signal, the video signal being encoded in conformance with one of a National Television Standards Committee standard and a Phase Alternating Line standard and the audio signal being a baseband signal.

14. The transmitter unit according to claim 12, wherein said encoder unit comprises a video codec, said video codec compressing the video signal to be in substantial conformance with a Motion Picture Experts Group standard selected from the group consisting of MPEG-1, MPEG-2 and MPEG-4.

15. The transmitter unit according to claim 12, wherein said encoder unit encodes the channel signal to be in substantial conformance with an International Telecommunications Union (ITU) standard selected from the group consisting of H.320 and H.323.

16. The transmitter unit according to claim 15, wherein said encoder unit comprises a video codec, said video codec compressing the video signal to be in substantial conformance with an ITU standard selected from the group consisting of H.261 and H.263.

17. The transmitter unit according to claim 16, wherein said video codec is responsive to a configuration command for setting at least one of the bit rate, a picture format, a temporal quantization and a spatial quantization.

18. The transmitter unit according to claim 17, wherein the picture format is selectable to either common intermediate format (CIF) or quarter common intermediate format (QCIF).

19 The transmitter unit according to claim 12, said transmitter unit including an input for receiving at least one alarm signal.

20. The transmitter unit according to claim 19, wherein said encoder unit further comprises a multiplexer which multiplexes the compressed channel signal and the at least one alarm signal into fixed sized frames in substantial conformance with ITU standard H.221.

21. The transmitter unit according to claim 20, wherein said encoder unit further converts the fixed size frames to the packet signal and transmits the packet signal to the monitoring location using a protocol selected from the group consisting of transport control protocol (TCP), User Datagram Protocol (UDP) and UDP-Private.

22. The transmitter unit according to claim 12, the demultiplexer command signal comprising at least one of a channel select command signal and a mode command signal.
